(19) United States
(12) Patent Application Publication
(10) Pub. No.: US 2018/0365992 A1
(43) Pub. Date: Dec. 20, 2018

(54) SYSTEM AND METHOD FOR ASSISTING A DRIVER OF A MOTOR VEHICLE IN A TRAFFIC JAM SITUATION

(71) Applicant: Lucas Automotive GmbH, Koblenz (DE)

(72) Inventor: Georg Schneider, Urbar (DE)

(21) Appl. No.: 16/006,952

(22) Filed: Jun. 13, 2018

(30) Foreign Application Priority Data
Jun. 14, 2017 (DE) 10 2017 005 645.5

(51) Int. Cl. G08G 1/0962; G08G 1/0967; G08G 1/01; G01C 21/36

(52) U.S. Cl. CPC G08G 1/09626; G01C 21/3697; G08G 1/0112; G08G 1/09675

(57) ABSTRACT

A control system for assisting a driver of an at least nearly stationary motor vehicle, based on environmental sensors of the motor vehicle, wherein the environmental sensors are adapted to detect the traffic situation at least in front of the at least nearly stationary motor vehicle. A user interface which is provided is suitable for at least transmitting a first signal to the driver of the motor vehicle. A controller which is provided is adapted to repeatedly determine the traffic situation by means of the environmental sensors, to determine a change In the traffic situation and, depending on the determined change in the traffic situation, to cause the user interface to transmit the first signal.

### BACKGROUND

A system for assisting a driver of a motor vehicle in a traffic jam situation and a corresponding method are disclosed herein. This system and the method can be used in particular to assist the driver in driver-controlled motor vehicles. Details thereof are defined in the claims; the description and the drawing also contain relevant details relating to the system and mode of operation as well as to variants of the system and of the method.

### TECHNICAL FIELD

Assistance provided to a driver of a motor vehicle by steering or driver assistance systems contributes to the comfort and to the operating safety of (motor) vehicles. Steering or driver assistance systems can detect external influences on the own driving situation and make the driver aware of these influences through visual, acoustic or haptic signals. The driver is thus able to identify the influences on the own driving situation in good time and react appropriately. The early identification of external influences on the driving situation and consequential appropriate reactions of the driver can indirectly also have a positive effect on the comfort and safety of other road users.

### UNDERLYING PROBLEM

A traffic jam situation which occurs in road traffic, for example as a result of a traffic route being blocked due to a road traffic accident, can force the driver of a motor vehicle to stop the motor vehicle at feast temporarily. Stopping can prolong the time for which the driver has to drive the motor vehicle in order to reach an intended destination. The time for which the driver must maintain his concentration or attention in order to drive the motor vehicle safely is thus also prolonged. However, the traffic jam situation does not allow the driver of the motor vehicle to stop concentrating or paying attention to the traffic situation completely, for example by momentarily closing his eyes and/or taking a nap. A resumption of the flow of traffic in particular requires the driver to react quickly so that he does not himself become an obstruction to the traffic and/or a danger to the safety of other road users. Furthermore, the switching off of a ventilation system, for example, due to a high pollutant load of the surrounding air caused by the traffic jam and/or falling fuel reserves require the attention of the driver.

In particular in the case of traffic jam situations which continue for a prolonged period of time, there can be, in addition to an intentional reduction In the level of attention of the driver, also an unintentional reduction in the level of attention of the driver, for example due to fatigue/exhaustion of the driver as a result of the overall increased driving time.

### Proposed Solution

A system/method assists the driver of an at least nearly stationary motor vehicle to react in good time to traffic situations which arise in the vicinity of the at least nearly stationary motor vehicle.

Stationary or nearly stationary Here includes a speed of from 0.0 m/s (0 km/h) to approximately 0.8 m/s (3 km/h). This is also referred to hereinbelow as a “stopped motor vehicle”.

This system/method for assisting the driver of the at least nearly stationary motor vehicle in a traffic jam situation is based on environmental sensors of the own motor vehicle. The environmental sensors of the own motor vehicle can be based on radar, lidar, (daylight or infrared) cameras, ultrasound or the like and/or on maps, which can be combined with the determination of the current location of the own motor vehicle. This location determination can be provided, for example, by a satellite-based navigation device. The environmental sensors can further comprise a radio receiver which is suitable for receiving external data, for example from a traffic monitoring station, a central congestion unit and/or a rescue or recovery service.

The environmental sensors are adapted to detect at least the traffic situation in front of the own motor vehicle. For example, the environmental sensors can detect a distance between the own motor vehicle and a further vehicle located in front of the own motor vehicle in the direction of travel by means of a camera or a lidar sensor.

There is further provided a user interface which is suitable for transmitting at least a first signal to the driver of the motor vehicle.

A controller which is likewise provided is adapted to repeatedly determine the traffic situation at least in front of the own motor vehicle by means of the environmental sensors, and a change In the traffic situation at least in front of the own motor vehicle. The determination of the change in the traffic situation takes place in particular by comparing the determined traffic situation with a previously determined traffic situation. The determination of the traffic situation and the change in the traffic situation can take place at defined time intervals.

A change In the traffic situation can be, for example, a change in the distance of the own motor vehicle from the further vehicle located in front of the own motor vehicle as a result of a movement of the further vehicle. Such a movement of the further vehicle can indicate an end to the traffic jam situation.

Depending on the determination of the change in the traffic situation, the controller causes the first signal to be transmitted to the driver by the user interface. This signal is suitable for raising the attention of the driver and directing it to the traffic situation, for example to the increase in the distance to the further vehicle located in front of the stopped motor vehicle.

This system is capable, by means of a signal, of actively increasing the intentionally or unintentionally reduced attention of the driver of the motor vehicle and thus effectively assisting him in terms of comfort and traffic safety.

### Further Embodiments and Advantageous Further Developments

In a variant, the control system for assisting a driver of a stopped motor vehicle can further comprise fuel reserve sensors. The fuel reserve sensors can be adapted to detect an available fuel reserve of the stopped motor vehicle. In this variant, the user interface is further suitable for transmitting a second signal to the driver of the motor vehicle. The second signal can be the same as the first signal or different from the first signal of the user interface. In this variant, the controller is adapted repeatedly to determine the available fuel reserve of the stopped motor vehicle and, depending on the determined available fuel reserve, to cause the user Interface to transmit the second signal to the driver.

An advantage is that the driver of the motor vehicle is actively warned before the available fuel reserve fails below a predetermined value, if, for example, the driver leaves the engine of the motor vehicle running in a cold environment in order to heat the motor vehicle, then the control system can actively warn the driver before the fuel reserve falls below a critical level, whereby the critical fuel reserve can be defined differently from a warning function of an implemented fuel gauge. For example, the controller can determine the distance to the closest fueling opportunity/open filling station with the aid of satellite navigation data, stored maps and/or data received by means of radio. On the basis of the determined distance to the closest fueling opportunity/open tilling station and stored or likewise determined average fuel consumption data, the controller is able to determine the critical fuel reserve situation-dependently, the control system warning the driver when the level falls below the critical fuel reserve.

In a variant, the control system for assisting a driver of a stopped motor vehicle can comprise ventilation sensors. The ventilation sensors are adapted to detect a pollutant load, in particular fine dust and/or nitrogen oxide pollution, of surrounding air used by the stopped vehicle for ventilation. In this variant, the user interface is further suitable for transmitting a third signal to the driver of the motor vehicle. The third signal can be the same as the first and/or second signal or different from the first and/or second signal of the user interface. In this variant, the controller is further adapted repeatedly to determine the pollutant toad of the air surrounding the stopped vehicle that is used for ventilation and, depending on the determined pollutant load, to causa the user interface to transmit the third signal to the driver.

An advantage hero is that the driver's attention is actively directed to the occurrence of an increased pollutant load in a traffic jam situation. The driver is thus given the opportunity to react deliberately, for example to switch off a ventilation system. In a further development, the ventilation system can also be switched off automatically.

In a variant, the control system for assisting a driver of a stopped motor vehicle can comprise engine temperature sensors. The engine temperature sensors can be adapted to detect an engine temperature of the stopped motor vehicle, in this variant, the user interface is further suitable for transmitting a temperature signal to the driver of the motor vehicle. In this variant, the controller is adapted repeatedly to determine the engine temperature of the stopped motor vehicle and, depending on the determined engine temperature, to cause the user interface to transmit the temperature signal to the driver.

An advantage is that the driver of the motor vehicle is actively warned if the engine temperature rises above a predetermined value. If, for example, the driver leaves the engine of the motor vehicle running In a warm environment for the purpose of air conditioning the motor vehicle, then the control system can actively warn him before a critical engine temperature is exceeded.

In a further development of the system and of the method, location data from a satellite-based navigation device can repeatedly be linked by the controller with congestion data which can be received In particular by the radio receiver. A determined estimated congestion duration can be displayed to the driver of the motor vehicle. The predetermined values for the engine temperature, the fuel reserve and/or the pollutant load of the surrounding air which in each case lead to the transmission of a signal can be determined and/or adapted taking Into account the estimated congestion duration. In particular, an increase in the estimated congestion duration can lead to an increase in the predetermined value for the fuel reserve and/or a lowering of the predetermined values for the engine temperature and/or the pollutant load of the surrounding air. Conversely, a shortening of the expected congestion duration can lead to an increase in the predetermined values for the engine temperature and/or the pollutant load of the surrounding air and/or a lowering of the predetermined value for the fuel reserve.

The first and/or second and/or third signal transmitted to the driver by the user interface can be a haptic signal, in particular a vibration of a driver's seat. Alternatively, the first and/or second and/or third signal can each be an acoustic signal. The acoustic signal can In particular be a warning sound which is emitted by at least one loudspeaker situated in the vehicle. The first and/or the second and/or the third signal can each be different warning sounds. In other embodiments, the first and/or second and/or third signal can also be a visual signal. In particular a change in an interior lighting of the vehicle and/or a visually discernible display in the interior of the vehicle.

In a variant, the controller can further be adapted to determine a reaction of the driver of the motor vehicle to the first and/or second and/or third signal. This reaction can be, for example, depending on the signal transmitted, a movement of the motor vehicle or the switching off of the motor vehicle engine. Depending on the determined reaction of the driver, the controller can cause the signal to be repeated. The repeated signal can be emitted with increased signal intensity, for example with Increased volume.

In one embodiment of the control system, the environmental sensors are further adapted to determine the traffic situation behind and/or laterally behind and/or laterally next to and/or laterally in front of the stopped motor vehicle.

For example, the control system can be adapted repeatedly to detect changes in the traffic situation, in particular movements of motor vehicles in adjacent traffic lanes, by means of the environmental sensors and to determine a change In the traffic situation In the adjacent traffic lanes. The determination of the change in the traffic situation can take place in particular by comparing the determined traffic situation with a previously determined traffic situation. The determination of the traffic situation and the change in the traffic situation can take place at defined time intervals.

In a variant, the control system can be configured to be activated automatically after the motor vehicle, in particular the running motor vehicle, has been stopped for a predetermined period of time, for example 5 minutes. In another variant, the control system can be configured to be activated manually by the driver of the motor vehicle.

A control method for assisting a driver of an at least nearly stationary motor vehicle comprises the steps:
repeatedly determining a traffic situation at least in front of the at least nearly stationary motor vehicle;
determining a change in the traffic situation;
transmitting at least a first signal to the driver of the motor vehicle depending on the determined change In the traffic situation.

The control method for assisting a driver of an at least nearly stationary motor vehicle can further comprise the following steps:
repeatedly determining an available fuel reserve of the at least nearly stationary motor vehicle;
transmitting at least a second signals to the driver of the motor vehicle depending on the determined available fuel reserve;
repeatedly determining a pollutant load of surrounding air used by the motor vehicle for ventilation;
transmitting at least a third signal to the driver of the motor vehicle depending on the determined pollutant load of the surrounding air used by the motor vehicle for ventilation.

### BRIEF DESCRIPTION OF THE DRAWING

Further objects, features, advantages and possible applications will become apparent from the following description of exemplary embodiments, which are not to be interpreted as being limiting, with reference to the accompanying drawings. In the drawings, all the features which are described and/or depicted show the subject-matter disclosed herein on their own or in any desired combination, also independently of their grouping in the claims or their references. The dimensions and proportions of the components shown in the figures are not necessarily to scale; they can differ from those shown in embodiments for implementation.

FIG. 1A shows, schematically, two vehicles in a traffic jam situation, wherein one of the vehicles has a control system according to the invention.

FIG. 1B shows, schematically, a change in the traffic situation of FIG. 1A.

FIG. 2 shows, schematically and by way of example, a control system for assisting a driver of a stopped motor vehicle.

### DETAILED DESCRIPTION OF THE DRAWINGS

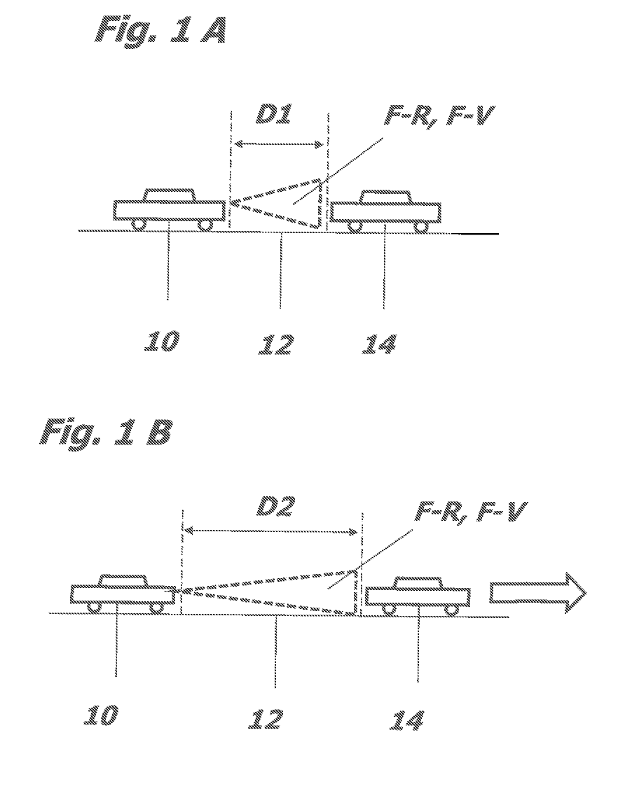

FIG. 1A shows, schematically, a driving situation in which an own (motor) vehicle 10 Is stopped on a section of road 12. In front of the own vehicle 10 in the direction of travel there is a second vehicle 14, which is likewise stopped on the section of road 12. The two vehicles 10, 14 in FIG. 1A are in a traffic jam situation, so that a distance D1 between the vehicles 10, 14 is constant as long as the traffic jam situation persists.

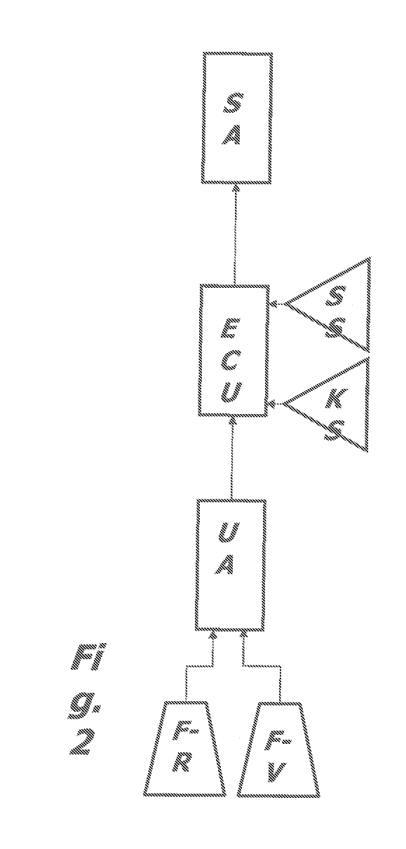

The own vehicle 10 has a control system for assisting a driver of the stopped motor vehicle, the structure of which control system Is shown schematically in FIG. 2.

A controller ECU—which is described in greater detail hereinbelow—associated with the vehicle serves for assisting the driver of the stopped motor vehicle 10. The controller ECU comprises a computer, which is not illustrated In detail, program/data storage means, input/output devices, etc. The controller ECU accesses an environment analyzer UA of the own vehicle, a fuel reserve sensor KB and a pollutant sensor SS. The feel sensor KS is arranged and configured to determine a fuel reserve of the own vehicle 10. The pollutant sensor SS is arranged and configured to determine the pollutant load of surrounding air used for ventilation of the own vehicle 10, whereby the pollutant sensor SS is suitable in particular for determining fine dust pollution and a nitrogen oxide content of the surrounding air.

In a further development (not shown), the control system can access road maps combined with a current location determination, for example from a satellite-based navigation system.

The environment analyzer UA accesses traffic situation data of the environmental sensors. In the embodiment shown, the environmental sensors further comprise radar sensors F-R and (Infrared and daylight) (video) cameras F-V, which are not shown In greater detail, the detection range of which Is shown schematically in the figures and with which the traffic situation in front of the vehicle 10 is detected.

The environment analyzer UA is adapted repeatedly to detect vehicles ahead or a further vehicle 14 stopped in front of the own vehicle 10 in the direction of travel. The environment analyzer UA is further adapted repeatedly to determine a distance between the own motor vehicle 10 and a further vehicle 14 that is ahead and/or stopped In the direction of travel. For example, the environment analyzer UA can determine the distance to the further vehicle 14 at a regular repetition interval of 10 seconds, in particular, the environment analyzer UA is also suitable for detecting rear brake lights of motor vehicles ahead by means of the cameras F-V.

The controller ECU Is adapted to detect an operating state of a vehicle engine and a movement state of the own motor vehicle, for example by means of a speed sensor or a wheel speed sensor of the motor vehicle that is already present for an ABS. The controller ECU is further adapted to determine time intervals.

The controller ECU is configured to assume a traffic jam situation when the own vehicle 10 is stopped or nearly stopped and operated with the engine switched on for a period of time of 5 minutes, and the environment analyzer UA detects a further vehicle 14 stopped in front of the own motor vehicle 10 in the direction of travel.

The controller ECU is adapted to store the distance to a further vehicle 14 that is repeatedly determined by the environment analyzer UA. The controller ECU is suitable in particular for storing the first and the second distances determined after the occurrence or assumption of the traffic jam situation and for determining a mean from the first and second determined distances, in a variant, the ECU is adapted to compare each further distance determined by the environment analyzer UA with the mean, wherein the controller ECU defines the determined distance and the mean as “corresponding” when their values differ from one another by less than 15% and as “not corresponding” when their values differ from one another by at least 15%.

If the distances determined by the environment analyzer UA correspond with the mean of the first and second determined distances, the controller ECU assumes that the traffic jam situation is continuing.

In a departure from the form of the control system described here, variants can be implemented In which the driver of the vehicle can manually influence the assumption of a traffic jam situation by the controller. In particular, the driver can specify the beginning and/or end of a traffic jam situation by a manual Input into the control system.

The controller ECU Is adapted repeatedly to determine the available fuel reserve of the vehicle by means of the feel sensor KS during the continued assumption of the traffic jam situation, for example at a regular repetition Interval of one minute. If the available fuel reserve falls below a predetermined value, the controller ECU causes a signal output SA for displaying a visually discernible warning signal in the Interior of the vehicle.

The controller ECU is adapted repeatedly to determine the pollutant lead of surrounding air used for ventilation of the vehicle by means of the pollutant sensor SS, for example at a regular repetition interval of 30 seconds. If the pollutant load exceeds a specified limit, for example a specific nitrogen oxide limit, the controller ECU causes the signal output SA for displaying a visually discernible warning signal in the interior of the vehicle. In a further development, the controller can automatically terminate ventilation of the vehicle with surrounding air if it is determined that the pollutant limit has been exceeded.

If a distance determined by the environment analyzer UA does not correspond with the mean from the first and second determined distances, the controller ECU assumes that the traffic jam situation has ended.

FIG. 1B shows such an ending of a traffic jam situation. As a result of the movement of the second vehicle 14, the distance between the own vehicle 10 and the second vehicle 14 increases, so that the distance D2 determined by the environment analyzer UA is greater than the previous distance D1 (see FIG. 1A).

The ECU is adapted, after an assumed ending of the traffic jam situation, to cause the signal output SA for emitting a haptic and an acoustic signal to the driver of the vehicle 10. For example, a vibration of a driver's seat and/or of a steering wheel and a warning sound from a vehicle loudspeaker can be caused. The ECU can further be adapted to repeatedly cause the signal output SA for emitting the haptic and/or acoustic signal until a change in the movement state of the own vehicle 10 is detected by the controller ECU.

In a further development, the acoustic signal to the driver in the case of a reduction in the distance determined by the environment analyzer UA can in particular be different from an acoustic signal in the case of an increase in the distance determined by the environment analyzer UA. For example, the acoustic signal in the case of a reduction in the determined distance can have an increased volume compared with the case of an increase in the determined distance.

The above-described variants and the structural and operational aspects thereof serve merely for better understanding of the structure, functioning and properties; they do not limit the disclosure, for example, to the exemplary embodiments. The figures are partly schematic, important properties and effects in some cases being shown on a significantly enlarged scale in order to clarify the functions, active principles, technical configurations and features. Any mode of functioning, any principle, any technical configuration and any feature that is/are disclosed in the figures or in the text can be combined freely and arbitrarily with ail the claims, any feature in the text and in the other figures, other modes of functioning, principles, technical configurations and features which are contained in this disclosure or follow therefrom, so that all conceivable combinations are to be assigned to the described variants. Combinations between all the individual implementations in the text, that is to say in every section of the description, in the claims, and also combinations between different variants in the text, in the claims and in the figures, are also included. The claims also do not limit the disclosure and thus the possible combinations of all the indicated features with one another. All the disclosed features are explicitly also disclosed herein individually and in combination with all the other features.

1. A control system for assisting a driver of an at least nearly stationary motor vehicle, based on environmental sensors of the motor vehicle, wherein
the environmental sensors are adapted to detect the traffic situation at least in front of the motor vehicle;
a user interface is provided which is suitable for at least transmitting a first signal to the driver of the motor vehicle;
a controller is provided and is adapted to:
repeatedly determine the traffic situation at least in front of the motor vehicle by means of the environmental sensors, and
determine a change in the traffic situation at least in front of the motor vehicle, and
depending on the determined change in the traffic situation, cause the user interface to transmit the first signal.

2. The control system as claimed in claim 1, further comprising fuel reserve sensors, wherein
the fuel reserve sensors are adapted to detect an available fuel reserve of the motor vehicle;
the user interface is further suitable for transmitting a second signal to the driver of the motor vehicle;
the controller is further adapted to:
repeatedly determine the available fuel reserve of the motor vehicle by means of the fuel reserve sensors,
depending on the determination of the available fuel reserve, cause the user interface to transmit the second signal.

3. The control system as claimed in claim 1, further comprising ventilation sensors, wherein,
the ventilation sensors are adapted to detect a pollutant load of surrounding air used by the motor vehicle for ventilation;
the user interface is further suitable for transmitting a third signal to the driver of the motor vehicle;
the controller is further adapted to:
repeatedly determine the pollutant load of the air surrounding the vehicle that is used for ventilation, by means of the ventilation sensors,
depending on the determination of the pollutant load, cause the user interface to transmit the third signal.

4. The control system as claimed in claim 1, wherein the first and/or second and/or third signal transmitted to the driver by the user interface
is a haptic signal, in particular a vibration of a driver's seat, and/or
is an acoustic signal, in particular a warning sound, and/or
is a visual signal, in particular a change in an interior lighting of the vehicle and/or a visually discernible display in the interior of the vehicle.

5. The control system as claimed in claim 1, wherein the controller is further adapted to:
determine a reaction of the driver of the motor vehicle to the first and/or second and/or third signal,
depending on the determination of the reaction of the driver of the motor vehicle, cause the user interface to repeat the transmission of the first and/or second and/or third signal, in particular with increased signal intensity.

6. The control system as claimed in claim 1, wherein the environmental sensors of the motor vehicle are further adapted to determine the traffic situation behind and/or laterally behind and/or laterally next to and/or laterally in front of the at least nearly stationary motor vehicle.

7. A control method for assisting a driver of an at least nearly stationary motor vehicle, comprising the steps:
repeatedly determining a traffic situation at least in front of the own stopped motor vehicle;
determining a change in the traffic situation;
transmitting a first signal to the driver of the motor vehicle in dependence on the determined change in the traffic situation.

8. The control method as claimed in claim 7, further comprising the steps:
repeatedly determining an available fuel reserve of the stopped motor vehicle;
transmitting a second signal to the driver of the motor vehicle in dependence on the determined available fuel reserve.

9. The control method as claimed in claim 7, further comprising the steps:
repeatedly determining a pollutant load of surrounding air used by the motor vehicle for ventilation;
transmitting a third signal to the driver of the motor vehicle in dependence on the determined pollutant load of the surrounding air used by the motor vehicle for ventilation.
